(19) United States
(12) Patent Application Publication
(10) Pub. No.: US 2015/0007206 A1
(43) Pub. Date: Jan. 1, 2015

(54) SET-TOP BOX AND TRACKING METHOD OF PLAYING VIDEO

(71) Applicant: HON HAI PRECISION INDUSTRY CO., LTD., New Taipei (TW)

(72) Inventor: YEN-HSU CHEN, New Taipei (TW)

(73) Assignee: HON HAI PRECISION INDUSTRY CO., LTD., New Taipei (TW)

(21) Appl. No.: 14/191,456

(22) Filed: Feb. 27, 2014

(30) Foreign Application Priority Data
Jun. 28, 2013 (TW) 102123129

(51) Int. Cl. H04N 21/4223; H04N 21/462; H04N 21/41; H04N 21/258; H04N 21/442; H04N 21/45

(52) U.S. Cl. CPC H04N 21/4223; H04N 21/44204; H04N 21/44218; H04N 21/44222; H04N 21/4524; H04N 21/41; H04N 21/25841; H04N 21/4622
USPC 725/12

(57) ABSTRACT

A set-top box includes a receiving module, a shooting module, a determining module and a positioning module. The receiving module receives a first data from a set-top box. The shooting module shoots an image characteristic of a user of the set-top box location. The determining module detects whether the image characteristic of the user shoot by the shooting module of the set-top box is same as the image characteristic of the user of the first data. The positioning module obtains the video content and remains the video content in the position.

### BACKGROUND

1. Technical Field

The disclosure relates to network communications, and particularly to a set-top box and tracking method for playing video.

2. Description of Related Art

With the widespread development and spread of internet technology, users at home can stream content and watch videos with different home video devices, such as set-top box, smart TV, mobile phone and computer, in different rooms. However, when a user is watching video, and the user wants to continue watching the video with another equipment in another room, other users must close the current video they are watching, resulting in a poor experience for the other users.

### BRIEF DESCRIPTION OF THE DRAWINGS

Many aspects of the present embodiments can be better understood with reference to the tracking drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an application environment diagram of one embodiment of a set-top box as disclosed.

FIG. 2 is a function module diagram of one embodiment of the set-top box of FIG. 1.

FIG. 3 is a structure diagram of one embodiment of the set-top box transmitting data as disclosed.

FIG. 4 is a flowchart of one embodiment of a method of the set-top box tracking for playing video.

FIG. 5 is a flowchart of another embodiment of a method of the set-top box tracking for playing video.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or another computer storage device.

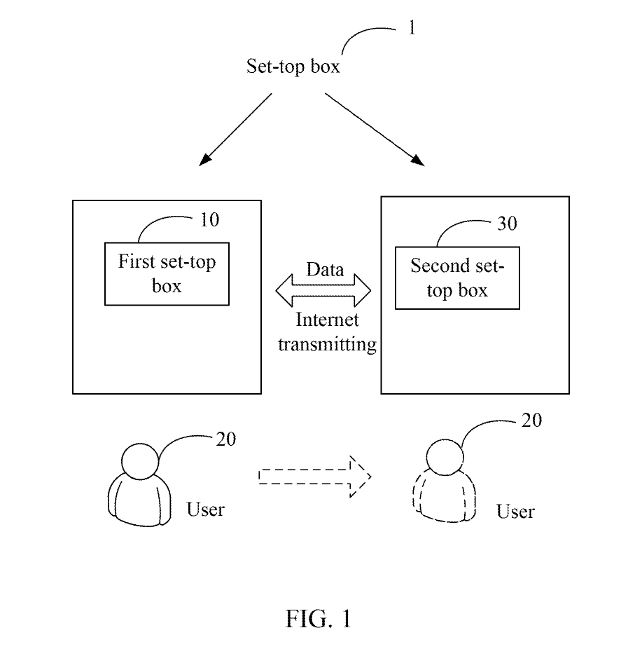

FIG. 1 is an application environment diagram of one embodiment of a set-top box 1. In one embodiment, a first set-top box 10 and a second set-top box 30 have the same function. For convenience, two set-top boxes are illustrated, and the set-top box 1 of the present disclosure is called the first set-top box 10 and the second set-top box 30. The first set-top box 10 communicates with the second set-top box 30 via the Internet, when a user wanders from the location of the second set-top box 30 to the location of the first set-top box 10. The second set-top box 30 transmits data to the first set-top box 10. After the first set-top box 10 receives the data, the user can watch the video content from the location of the second set-top box 30 through the first set-top box 10, and the user does not need to manually operate the first set-top box 10.

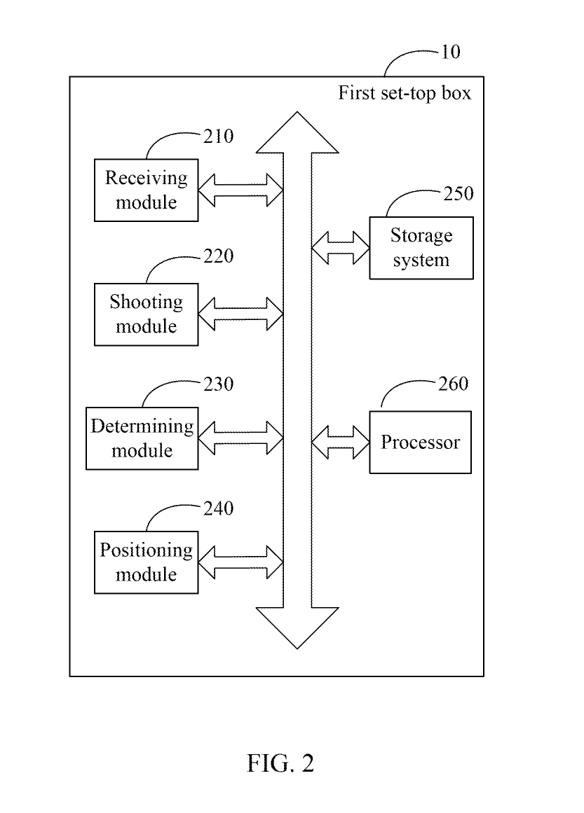

FIG. 2 is a function module diagram of one embodiment of the first set-top box 10 of FIG. 1. In one embodiment, the first set-top box 10 comprises a receiving module 210, a shooting module 220, a determining module 230, a positioning module 240, a storage system 250, and a processor 260. The modules 210, 220, 230, 240 comprise software programs which are stored in the storage system 250, and the processor 260 runs the software programs to achieve functions of these modules 210, 220, 230, 240. The shooting module 220 can be embedded in the set-top box 10, and can also be a peripheral of the set-top box 10, such as a camera.

In one embodiment, when the user 20 is watching video in the location of the first set-top box 10, the shooting module 220 shoots a first image characteristic of the user 20 location of the first set-top box 10, and the first set-top box 10 records a first video content internet protocol (IP) address and a first video content successive frame. Moreover, the positioning module 240 combines the first image characteristic of the user 20 location of the first set-top box 10, the first video content internet protocol (IP) address, and the first video content successive frame into a first data. The set-top box 10 can then transmit the first data to the second set-top box 30 through the internet.

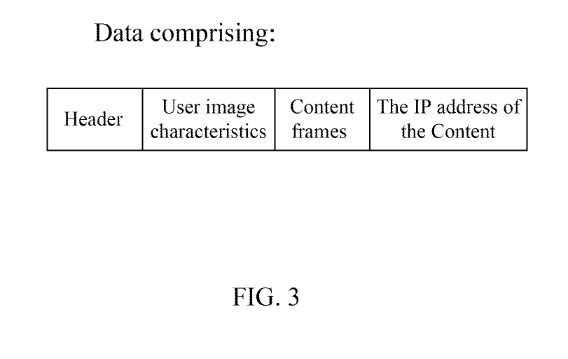

FIG. 3 is a structure diagram of one embodiment of the set-top box 1 transmitting data. In one embodiment, the set-top box 1 of the present disclosure is called the first set-top box 10, the data of FIG. 3 is the first data, and comprises a header, an image characteristics of the user 20, an IP address of the video content of the user 20, and a video content frame of the video content of the user 20.

When the user 20 wanders from the location of the first set-top box 10 to the location of the second set-top box 30, the receiving module 210 of the second set-top box 30 receives the first data.

If the user 20 turns on the switch of the second set-top box 30 and wants to watch the video content of the first set-top box 10, the shooting module 220 of the second set-top box 30 will shoot a second image characteristic of the user 20 and store the image characteristic of the user 20.

The determining module 230 of the second set-top box 30 then detects whether the first image characteristic of the user 20 of the first data is the same as the second image characteristic of the user 20 shoot by the shooting module 220 of the second set-top box 30. If the first image characteristic of the user 20 of the first data is not the same as the second image characteristic of the user 20 shot by the shooting module 220 of the second set-top box 30, this signifies the user 20 is a different person, and the second set-top box 30 can not play the video content played by the first set-top box 10.

If the first image characteristic of the user 20 of the first data is the same as the second image characteristic of the user 20 shot by the shooting module 220 of the second set-top box 30, this signifies the user 20 is the same person. The positioning module 240 of the second set-top box 30 then obtains the video content according to the first video content IP address of the first data, and maintains the video content in the position the user 20 left the first set-top box 10 according to the first video content successive content frame of the first data. Thus, the user 20 can continue to watch the video content when the user 20 leaves the first set-top box 10.

When the user 20 wanders from the location of the first set-top box 10 to the location of the second set-top box 30, the user 20 does not need to manually operate the second set-top box 30 and watch the video content directly. Once the user 20 begins to watch the video content, the second set-top box 30 deletes the first data, and also notifies the first set-top box 30 to delete the first data through the internet. When the user 20 wanders from the second set-top box 30 to the first set-top box 10, the second set-top box 30 also combines the second image characteristic of the user 20 at the second set-top box 30, a second video content IP address, and a second video content successive frame into a second data, and transmits the second data to the first set-top box 10 through the internet.

When the user 20 wanders from the location of the second set-top box 30 to the location of the first set-top box 10, the shooting module 220 of the first set-top box 10 shoots a third image characteristic of the user 20 and stores the third image characteristic of the user 20. The receiving module 210 of the first set-top box 10 also receives the second data. The determining module 230 of the first set-top box 10 then detects whether the third image characteristic of the user 20 shot by the shooting module 220 of the first set-top box 10 is the same as the second image characteristic of the user 20 of the second data. If the third image characteristic of the user 20 shot by the shooting module 220 of the first set-top box 10 is the same as the second image characteristic of the user 20 of the second data, the positioning module 240 of the set-top box 10 combines a third video content IP address and a third video content successive frame to a third data, and transmits the third data to the second set-top box 30 through the internet.

After the video content is completed, the receiving module 210 of the first set-top box 10 provides a video fragment which is the video content from the video frame of the second data to the video frame of the third data, and the user 20 can select to watch the video fragment or delete the video fragment. Thus, the user 20 can select the video fragment.

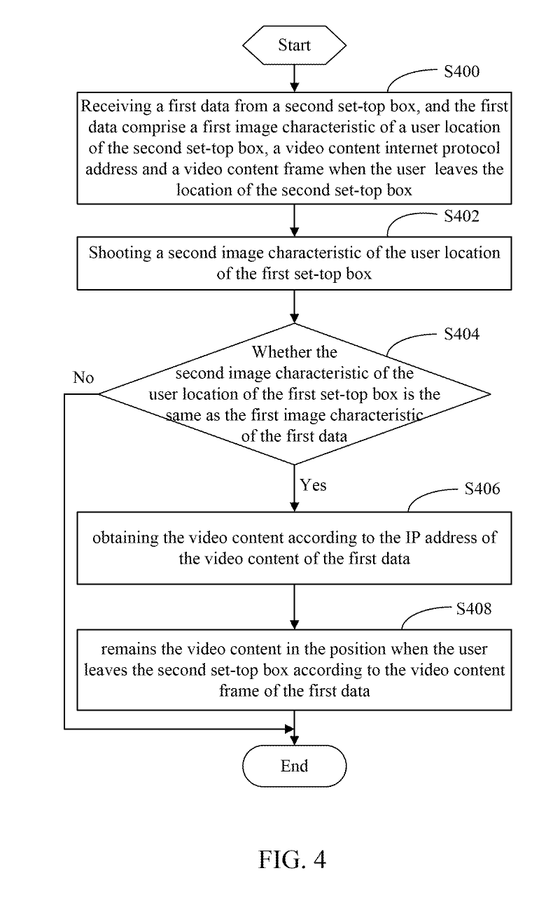

FIG. 4 is a flowchart of one embodiment of a method of the set-top box 1 tracking for playing video. The method is applied for the first set-top box 10, and achieved by the modules shown in FIG. 2. In one embodiment, the modules of FIG. 2 is used for achieving the method.

In one embodiment, when the user 20 is watching video in the location of the first set-top box 10, the shooting module 220 of the second set-top box 30 shoots a first image characteristic of the user 20. When the user 20 wanders from the location of the second set-top box 30 to the location of the first set-top box 10, the second set-top box 30 combines the first image characteristic of the user 20, a video content IP address, and a video content frame into a first data, and transmits the first data to the in one embodiment, set-top box 10 through the internet.

When the user 20 enters the location of the first set-top box 10, the first set-top box 10 as disclosed can track to play video, so the user 20 can watch the video content through the second set-top box 30.

In block S400, the receiving module 210 receives the first data transmitted by the second set-top box 30. In one embodiment, the first data comprises the first image characteristic of the user 20 location of the second set-top box 30, the first video content internet IP address, and the first video content successive frame, when the user leaves the location of the second set-top box 30.

In block S402, the shooting module 220 shoots a second image characteristic of the user 20 location of the first set-top box 10.

In block S404, the determining module 230 detects whether the second image characteristic of the user 20 location of the first set-top box 10 is the same as the first image characteristic of the first data.

In block S406, If the second image characteristic of the user 20 location of the first set-top box 10 is the same as the first image characteristic of the first data, the positioning module 240 of the first set-top box 10 obtains the video content according to the first video content IP address of the first data.

In block S408, the positioning module 240 maintains the video content in the position the user leaves the second set-top box 30 according to the first video content successive frame of the first data.

The user 20 can watch the video content when the user 20 leaves the first set-top box 10. When the user 20 wander from the location of the first set-top box 10 to the location of the second set-top box 30, the user 20 does not need to manually operate the second set-top box 30 and watch video content directly. Once the user 20 begins watching the video content, the second set-top box 30 deletes the first data, and also notifies the second set-top box 30 to delete the first data through the internet.

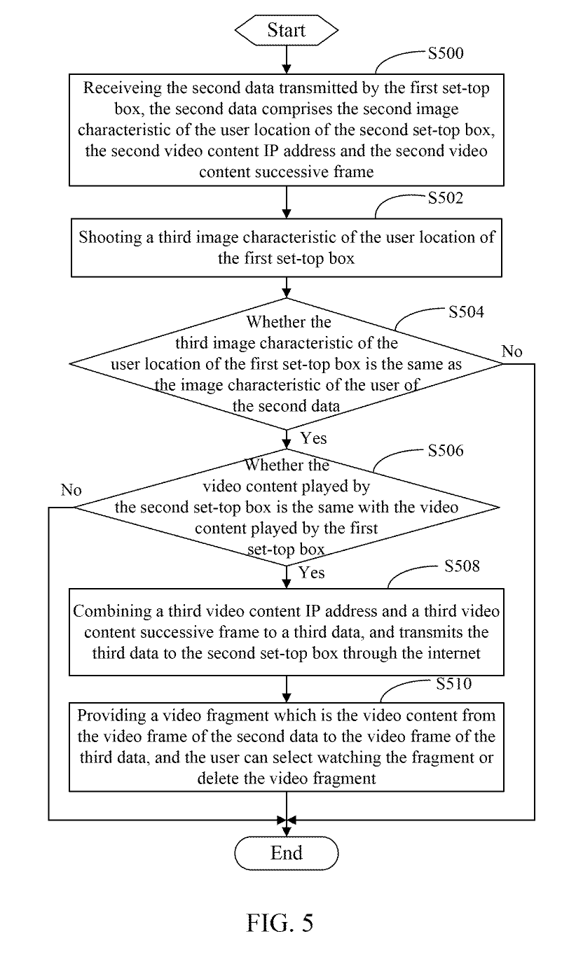

FIG. 5 is a flowchart of another embodiment of a method of the set-top box 1 tracking for playing video. The method is applied for the first set-top box 10, and achieved by the modules shown in FIG. 2. In one embodiment, the modules of FIG. 2 is used for achieving the method.

When the user 20 needs to wander from the first set-top box 10 to the second set-top box 30, the first set-top box 10 also combines the second image characteristic of the user 20 location of the second set-top box 30, a second video content IP address, and a second video content successive frame into a second data when the user leaves the location of the another set-top box 30, and transmits the second data to the second set-top box 30 through the internet.

In block S500, the receiving module 210 receives the second data transmitted by the first set-top box 10. In one embodiment, the second data comprises the second image characteristic of the user 20 location of the second set-top box 30, the second video content IP address, and the second video content successive frame when the user 20 leaves the location of the second set-top box 30.

In block S502, the shooting module 220 shoots a third image characteristic of the user 20 location of the first set-top box 10.

In block S504, the determining module 230 detects whether the third image characteristic of the user 20 shoot by the shooting module 220 of the first set-top box 10 is the same as the second image characteristic of the user 20 of the second data.

In block S506, If the third image characteristic of the user 20 shot by the shooting module 220 of the first set-top box 10 is the same as the second image characteristic of the user 20 of the second data, then the determining module 230 detects whether the video content played by the second set-top box 30 is the same as the video content played by the first set-top box 10.

In block S508, if the video content played by the second set-top box 30 is the same as the video content played by the first set-top box 10, the positioning module 240 of the second set-top box 30 combines a third video content IP address and a third video content successive frame to a third data, and transmits the third data to the second set-top box 30 through the internet.

In block S510, after the video content is completed, the receiving module 210 of the first set-top box 10 provides a video fragment which is the video content from the video frame of the second data to the video frame of the third data, and the user 20 can select to watch the video fragment or delete the video fragment. Thus, the user 20 can select when to watch the video fragment.

The foregoing disclosure of the various embodiments has been presented for purposes of illustration and description. It is not intended to be exhaustive or to limit the present disclosure to the precise forms disclosed. Many variations and modifications of the embodiments described herein will be apparent to one of ordinary skill in the art in the light of the above disclosure. The scope of the present disclosure is to be defined only by the claims appended hereto and their equivalents.

What is claimed is:

1. A set-top box comprising a processor and a storage system, the storage system storing one or more software programs in the form of computerized codes operable to be executed by the processor, the one or more software programs comprising:
a receiving module, receiving a first data from another set-top box, wherein the first data comprises a first image characteristic of a user location of the another set-top box, a first video content internet protocol (IP) address and a first video content successive frame when the user leaves location of the another set-top box;
a shooting module, shooting a second image characteristic of the user location of the set-top box;
a determining module, detecting whether the second image characteristic of the user location of the set-top box is the same as the first image characteristic of the user location of the another set-top box; and
a positioning module, obtaining the video content according to the first video content IP address of the first data when the second image characteristic of the user is the same as the first image characteristic of the user, and remaining the video content in the position when the user leaves the another set-top box according to the first video content successive frame of the first data.

2. The set-top box of claim 1, wherein the receiving module further receives a second data from the another set-top box, wherein the second data comprises the second image characteristic of the user location of the set-top box, a second video content IP address and a second video content successive frame when the user leaves the location of the another set-top box.

3. The set-top box of claim 2, wherein the determining module further detects whether the video content played by the another set-top box is the same with the video content played by the set-top box according to the second video content IP address of the second data.

4. The set-top box of claim 3, wherein the positioning module further combines a third video content IP address and a third video content successive frame to a third data, transmits the third data to the another set-top box through the internet when the video content played by the another set-top box is the same with the video content played by the set-top box.

5. The set-top box of claim 4, wherein the receiving module further provides a video fragment which is the video content from the second video content successive frame to the third video content successive frame after the video content is completed.

6. A tracking method of playing video of a set-top box comprising:
receiving a first data from another set-top box, wherein the first data comprises a first image characteristic of a user location of the another set-top box, a first video content internet protocol (IP) address and a first video content successive frame when the user leaves the location of the another set-top box;
shooting a second image characteristic of the user location of the set-top box;
detecting whether the second image characteristic of the user location of the set-top box is the same as the first image characteristic of the user location of the another set-top box; and
obtaining the video content according to the first video content IP address of the first data when the second image characteristic of the user location of the set-top box is the same as the first image characteristic of the user, and remaining the video content in the position when the user leaves the another set-top box according to the first video content successive frame of the first data.

7. The tracking method of playing video of the set-top box of claim 6 further comprising:
receiving a second data from the another set-top box, wherein the second data comprises a third image characteristic of the user location of the another set-top box, a second video content IP address and a second video content successive frame when the user leaves the location of the another set-top box;
detecting whether the video content played by the another set-top box is the same with the video content played by the set-top box according to the second video content IP address of the second data;
combining a third video content IP address and a third video content successive frame to a third data, transmits the third data to the another set-top box through the internet when the video content played by the another set-top box is the same with the video content played by the set-top box; and
providing a video fragment which is the video content from the second video content successive frame to the third video content successive frame after the video content is completed.
